(19) United States
(12) Patent Application Publication
(10) Pub. No.: US 2026/0104097 A1
(43) Pub. Date: Apr. 16, 2026

(54) VALVE ARRANGEMENT AND LIQUID TREATMENT INSTALLATION FOR A VEHICLE WASHING INSTALLATION

(71) Applicant: WashTec Holding GmbH, Augsburg (DE)

(72) Inventor: Stefan Mayer, Neusaess (DE)

(73) Assignee: WashTec Holding GmbH, Augsburg (DE)

(21) Appl. No.: 19/357,869

(22) Filed: Oct. 14, 2025

(30) Foreign Application Priority Data
Oct. 15, 2024 (DE) 102024129898.7

(51) Int. Cl. F16K 11/087; B01D 21/24; B01D 29/90; B01D 35/157; B01D 36/04

(52) U.S. Cl. CPC F16K 11/0876; B01D 21/2444; B01D 29/90; B01D 35/1573; B01D 36/04; B01D 2201/165

(57) ABSTRACT

A valve arrangement includes a housing, which has a central port and at least three further ports and surrounds a housing cavity in which a valve body is arranged to rotate about an actuatable adjustment axis relative to the housing. Each of the ports is connected to the housing cavity. The valve body has at least three flow channels which each extend from an assigned opening to a common junction chamber. The openings and the ports are arranged so that the adjustment axis runs through the first opening and the first flow channel is connected to the central port. In a first angle position of the valve body relative to the adjustment axis, the second flow channel is connected to the first port and the third flow channel is connected to the second port. The valve arrangement can be used for a liquid treatment installation for a vehicle washing installation.

### FIELD OF THE INVENTION

The present invention relates to a valve arrangement having a housing, which has a central port and at least three further ports. The housing surrounds a housing cavity, in which a valve body is arranged so as to rotate about an actuatable adjustment axis relative to the housing. Each of the ports of the housing is fluidically connected to the housing cavity. The valve body has at least one first, one second and one third flow channel, which in each case extend from a first, a second and a third assigned opening to a common junction chamber. Furthermore, the invention relates to a liquid treatment installation for a vehicle washing installation having a liquid reservoir for the vehicle washing installation, a sedimentation device for removing sediment and a filter device having an inlet and an outlet. The liquid treatment installation furthermore has a valve system in order to control the flow of liquid in the liquid treatment installation. The valve system in particular comprises the valve arrangement according to the invention.

### BACKGROUND OF THE INVENTION

In a vehicle washing installation, for example a gantry washing installation or a car wash, after the vehicle has been washed, the washing water is collected, processed and supplied again as industrial water for the washing process. An installation for the treatment of liquids is used for treating the washing water, in which the industrial water is pumped through a filter device. In order to control the liquid flow in the liquid treatment installation, a valve system is used.

A system for treating industrial water is described in DE 10 2018 105 678 A1. The system comprises a storage tank, from which industrial water is conveyed via a filter arrangement into a collection tank, from which washing water can be withdrawn for the vehicle washing installation. A valve battery is provided to control the liquid flow. The valve battery can control the flow of the industrial water through the filter device. Furthermore, the flow direction can be reversed by the valve battery, in order to remove any settled impurities from the filter device through backwashing. Furthermore, the filter battery can be joined to a treated water supply line when it is a closed tank system.

A disadvantage of the valve systems and valve arrangements used in liquid treatment installations is that the connection options are limited and the switching times are too long.

### SUMMARY OF THE INVENTION

Accordingly, one aspect of the present invention relates to providing a valve arrangement and a liquid treatment installation of the type mentioned above, which has flexible connection options for the liquid flows and with which different liquid flows can be switched between quickly.

According to the invention, this object is solved by a valve arrangement as disclosed herein and by a liquid treatment installation as disclosed herein. Advantageous embodiments and developments are also disclosed herein.

The valve arrangement according to the invention comprises a housing, which has a central port and at least three further ports and surrounds a housing cavity in which a valve body is arranged so as to rotate about an actuatable adjustment axis relative to the housing. Each of the ports of the housing is fluidically connected to the housing cavity. The valve body has at least one first, one second and one third flow channel, which in each case extend from a first, a second and a third assigned opening to a common junction chamber. The openings of the valve body and the ports of the housing are arranged so that the adjustment axis runs through the first opening and the first flow channel is fluidically connected to the central port. In a first angle position of the valve body in relation to the adjustment axis, the second flow channel is fluidically connected to a first of the at least three further ports and the third flow channel is fluidically connected to a second of the at least three further ports.

The valve arrangement advantageously has very flexible connection options. Not only can two ports of the housing be fluidically connected by the valve body, but three ports of the housing can be fluidically connected via the valve body. This means that it is possible to provide very variable flow circuits, in particular in a liquid treatment installation. Furthermore, it is also possible, due to the embodiment of the valve body to switch between different fluid connections of the ports of the housing very quickly.

According to one embodiment of the valve arrangement, in a second angle position of the valve body in relation to the adjustment axis, the second flow channel is fluidically connected to the second port and the third flow channel is fluidically connected to a third of the at least three further ports.

According to a further embodiment of the valve arrangement, in a third angle position of the valve body in relation to the adjustment axis, the second flow channel is fluidically connected to the third port and the third flow channel is blocked by the valve body.

Finally, in a fourth angle position of the valve body in relation to the adjustment axis, the second flow channel is blocked by the valve body and the third flow channel is fluidically connected to the first port.

Due to the different angle positions of the valve body inside the housing, different ports of the housing can be connected to each other very flexibly and quickly, giving rise to different fluid connections between the ports.

According to a further embodiment of the valve arrangement, the axes of the flow channels are each perpendicular to one another, wherein the axis of the first flow channel lies on the adjustment axis. In this case, an axis is understood to mean a straight line inside the respective flow channel. In a cylindrical flow channel, the axis coincides with the axis of the cylinder.

Advantageously, in this case in each angle position of the valve body relative to the housing, the first flow channel is connected to the central port of the housing. By rotating the valve body about the adjustment axis, the further flow channels that are perpendicular to each other can then be aligned with respect to the further ports of the housing, so that a fluid connection to one or two of the further ports is created or the flow through the flow channel is blocked.

According to a further embodiment of the valve arrangement, the housing cavity is a hollow sphere and the valve body is spherical, so that the spherical valve body sits sealingly in the hollow sphere formed by the housing. Advantageously, this embodiment of the housing and the valve body can be produced with a particularly accurate fit in order to ensure in particular a sealed arrangement of the valve body inside the housing. Furthermore, this embodiment is advantageous for rotating the valve body about the adjustment axis inside the housing.

According to another embodiment, the housing cavity is a hollow cylinder, the axis of which in particular coincides with the adjustment axis. In this case, the valve body is cylindrical so that the cylindrical valve body sits sealingly in the hollow cylinder formed by the housing. Also, in this embodiment, the valve body can be rotated about the adjustment axis in the housing so that the valve body sits sealingly in the housing cavity of the housing, and simultaneously can be rotated very easily and quickly about the adjustment axis, in order to provide different switching positions of the valve arrangement.

The liquid treatment installation according to the invention for a vehicle washing installation comprises a liquid reservoir for the vehicle washing installation, a sedimentation device for removing sediment and a filter device having an inlet and an outlet. The liquid treatment installation also comprises a valve system which, in a first switching position, guides liquid from the sedimentation device into the inlet of the filter device, through the filter device and from the outlet of the filter device into the liquid reservoir and, in a second switching position, supplies liquid from the sedimentation device past a treatment system to the filter device.

In the case of the liquid treatment installation, in the first switching position, the liquid is supplied to the liquid reservoir so that it can be used as industrial water by the vehicle washing installation. Advantageously, the valve system provides a second switching position, in which the liquid is not guided through the filter device, but is directly supplied to a treatment system by the sedimentation device. Thus circulation past the filter device is provided, which enables the supply of liquid removed from the sedimentation device to a separate treatment, wherein the liquid flow is provided by the same valve system which also controls the filtering of the liquid before supplying it into the liquid reservoir.

In the second switching position of the valve system, advantageously unpressurised circulation occurs because the liquid is passed to the filter device. In this case, only the line resistances have to be overcome. When the liquid is circulated without passing through the filter device, advantageously the circulation speed of the tank system can be increased and the filter device has to be backwashed less often.

According to an embodiment of the liquid treatment installation, the sedimentation device has a sedimentation tank and a discharge tank, wherein a drain of the sedimentation tank is fluidically connected to the discharge tank.

The sedimentation tank is designed in particular such that solid particles, which are entrained in the supplied liquid, i.e. in particular the dirty water of the vehicle washing installation, settle. The sedimentation tank can, for example, be a part of a so-called sludge separator.

The treatment system can, for example, be a device for ozonating or for chemically treating the liquid. The treatment system may also be a bioreactor. The liquid treated by the treatment system can in turn be returned to the sedimentation device. Alternatively, the treated liquid can also be drained from the liquid treatment installation.

According to one embodiment of the liquid treatment installation, the valve system has a first valve arrangement, as described above. In this case, in particular the central port of the first valve arrangement is connected to the inlet of the filter device. Advantageously, a fluid connection from the inlet of the filter device to the junction chamber thus always exists inside the valve body. Then a fluid connection can be created to one or more of the further ports of the housing of the first valve arrangement via the valve body.

According to one embodiment of the liquid treatment installation, the first port of the first valve arrangement is connected to the sedimentation device. The first port is in particular connected to the discharge tank.

The second port of the first valve arrangement is in particular connected to the treatment system. The third port of the first valve arrangement can also be connected to the sedimentation device, in particular to the sedimentation tank.

According to a further embodiment of the liquid treatment installation, the valve system has a second valve arrangement, as described above. The valve thus has in particular a first and second valve arrangement, which in each case are designed as described above.

The central port of the second valve arrangement is in particular connected to the outlet of the filter device. Advantageously, in each angle position of the valve body, the second valve arrangement has a fluid connection from the outlet of the filter arrangement to the junction chamber, from which fluid connections to the further ports can be created depending on the angle position of the valve body.

The first port of the second valve arrangement is in particular connected to the liquid reservoir.

The second port of the second valve arrangement is in particular connected to the sedimentation device. In particular, the second port of the second valve arrangement is connected to the sedimentation tank.

The third port of the second valve arrangement is in particular also connected to the sedimentation device. In this case, it is however connected to the discharge tank.

With the embodiment of the liquid treatment installation having the two valve arrangements described above, there is the advantage that owing to the different angle positions of the valve bodies of the valve arrangements, the following flow paths for the liquid can be switched quickly:

In the case of a flow path for filtering, the liquid can be removed from the discharge tank, then flow through the filter device and then be supplied to the liquid reservoir.

In the case of a flow path for backwashing, the liquid can be removed from the discharge tank, then flow into the filter outlet in order to flow from there the filter device inversely to the filter flow to the filter inlet and flow from the filter inlet into the sedimentation tank. Advantageously, during such backwashing, dirt particles are swirled up in the filter device and supplied to the sedimentation tank, in which the dirt particles can settle. Simultaneously, during such backwashing, the filter material, for example sand or gravel, is swirled up.

In the case of a flow path for compaction, the filter material swirled up after backwashing can in turn be compacted in the filter bed. In this case, the liquid flows from the discharge tank through the filter device. In this case, advantageously in the second valve arrangement, the port to the liquid reservoir and to the sedimentation tank is switched open. However, a counterpressure occurs in the liquid reservoir, so that in this case the liquid is only guided back into the sedimentation tank. Thus, it circulates in the liquid treatment installation, wherein it advantageously compacts the filter bed of the filter device again.

In the case of a flow path for circulation, the liquid flows advantageously from the discharge tank both to the first valve arrangement as well as to the second valve arrangement. In the valve arrangements, in each case the passage to the filter device is open, so that both the filter inlet as well as the filter outlet are subject to pressure. In this case, advantageously as a result, liquid does not flow through the filter device. Instead, the liquid flows from a circulation line into the treatment system, in which it can be treated as described above. Advantageously, in this case it is an unpressurised circulation, as the liquid is not guided through the filter device, whereby energy can be saved when operating the liquid treatment installation.

Finally, the valve arrangements can also be switched so that all passages are closed.

The terms “first”, “second”, “third”, etc. used in this document are understood in the sense that they make a distinction between different elements. The number of these elements is not to be restricted thereby. These terms are only used in order to differentiate one element from another element. For example, a first port, as described here, could be referred to as a second port, without deviating from the teaching of the present invention. Thus, when a second element is specified in one embodiment, a first element may or may not be present.

### BRIEF DESCRIPTION OF THE DRAWINGS

The invention will now be explained using exemplary embodiments with reference to the drawings.

FIG. 1 shows an exemplary embodiment of the valve arrangement,

FIG. 2 shows the housing of the valve arrangement shown in FIG. 1,

FIG. 3 shows the valve body of the valve arrangement of FIG. 1,

FIGS. 4A to 4D illustrate different angle positions of the valve body in the housing of the valve arrangement,

FIG. 5 schematically shows an exemplary embodiment of the liquid treatment installation, and

FIGS. 6 to 10 illustrate different switching positions of the valve arrangements of the liquid treatment installation of FIG. 5.

### DETAILED DESCRIPTION

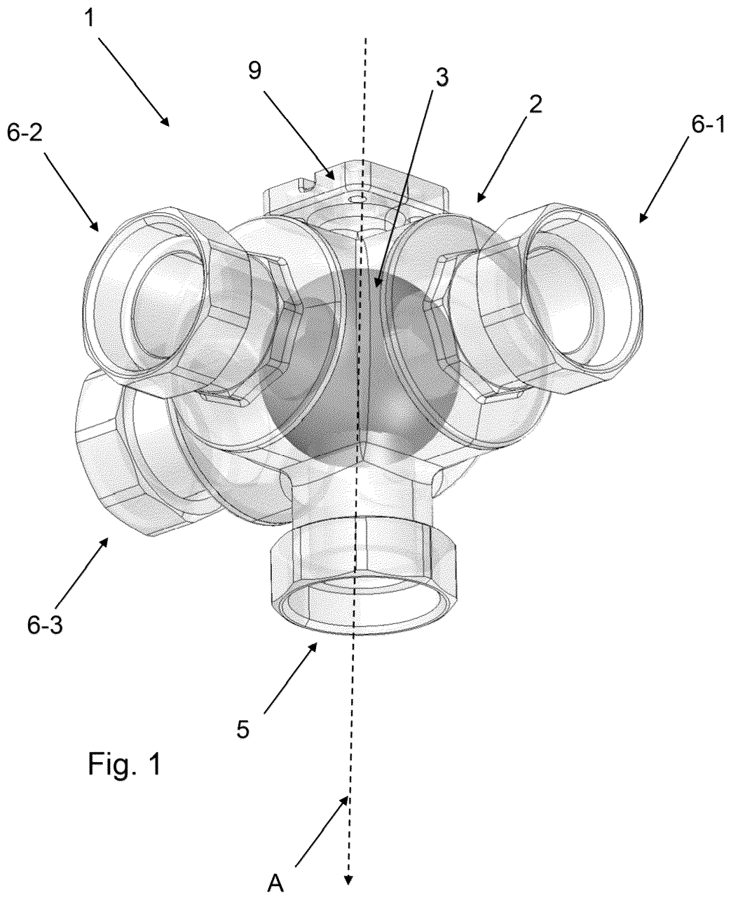

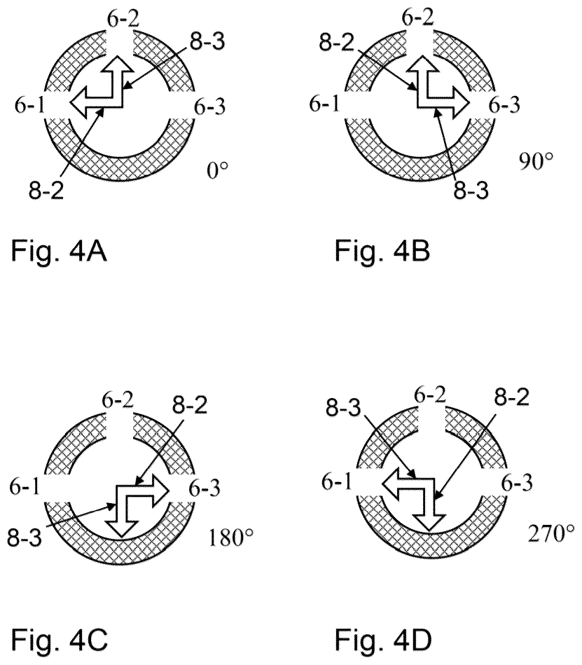

Firstly, an exemplary embodiment of the valve arrangement 1 is described with reference to FIGS. 1 to 4 (FIGS. 4A to 4D):

The valve arrangement 1 comprises a housing 2 having several ports and a valve body 3, which is mounted sealingly in a housing cavity in the interior of the housing 2, as shown in FIG. 1. The housing 2 also has an actuating device 9, by means of which the valve body 3 can be rotated manually or electronically inside the housing about an adjustment axis A, in order to produce fluid connections between ports of the housing 2, as is explained later in detail.

The housing 2 has a central port 5. The adjustment axis A is inside the central port 5 and the connection of the central port 5 to the housing cavity in which the valve body 3 is accommodated.

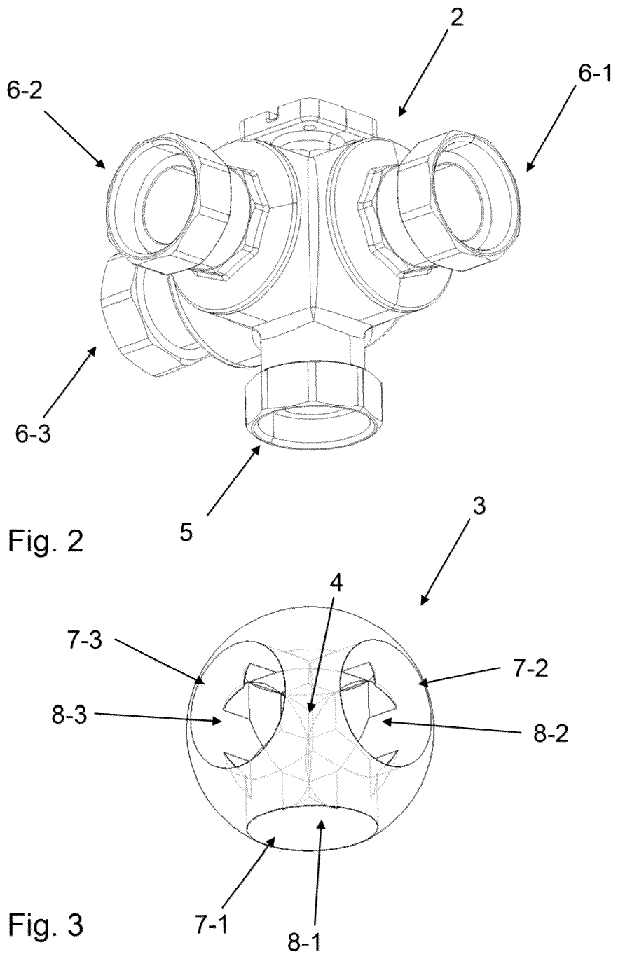

A first, a second and a third further port 6-1, 6-2, 6-3 are arranged in one plane perpendicular to the adjustment axis A. In the present exemplary embodiment, the axis from the centre point of the housing cavity to the first further port 6-1 forms an angle of 90° with the axis from the centre point of the housing cavity to the second further port 6-2, the axis from the centre point of the housing cavity to the second further port 6-2 also forms an angle of 90° with the axis from the centre point of the housing cavity to the third further port 6-3, and the axis of the first further port 6-1 and the axis of the third further port 6-3 form an angle of 180°. The ports of the housing, i.e. the central port 5 and the three further ports 6-1 to 6-3, are shown in their arrangement according to the exemplary embodiment in FIGS. 1 and 2.

In another exemplary embodiment, the axes the three further ports 6-1 to 6-3 each form an angle of 120°. In even further exemplary embodiments, even further angle positions of the further ports are possible, which are also not necessarily arranged in one plane.

The ports 5, 6-1, 6-2, 6-3 of the housing 2 are fluidically connected to the housing cavity in which the valve body 3 is accommodated. The valve body 3 can block a port depending on the angle position or enable flow to another port, as described in the following.

The valve body 3 is shown in detail in FIG. 3. It has a first flow channel 8-1, a second flow channel 8-2 and a third flow channel 8-3. The flow channels 8-1 to 8-3 open out into the interior of the valve body 3 into a junction chamber 4, which creates a fluid connection of the flow channels 8-1 to 8-3. On the outer end, the flow channels 8-1 to 8-3 each open out into openings of the valve body 3, i.e. into a first opening 7-1, a second opening 7-2 and a third opening 7-3.

The outer surface of the valve body 3 has the shape of a sphere, which is only interrupted by the openings 7-1 to 7-3. Corresponding to the spherical shape of the valve body 3, the housing cavity is designed as a hollow sphere in the interior of the housing 2, so that the valve body 3 is accommodated by the housing 2 in the housing cavity in the valve arrangement 1 in such a way that the valve body 3 can be rotated about the adjustment axis A by means of the actuating device 9, but the surface of the valve body 3 sits in the housing cavity such that a liquid tight connection is created. Thus, it is not possible for liquid to get from one of the flow channels 8-1 to 8-3 between the surface of the valve body 3 and the interior surface of the housing cavity of the housing 2 to another one of the flow channels 8-1 to 8-3.

The valve body 3 also sits in the housing cavity of the housing 2 such that the adjustment axis A runs through the first opening 7-1 and through the first flow channel 8-1. Irrespective of the angle position of the valve body 3, there is therefore always a fluid connection from the central port 5 of the housing 2 through the first opening 7-1 of the valve body 3, through the first flow channel 8-1 into the junction chamber 4 of the valve body 3. Due to different angle positions of the valve body 3, fluid connections of the first and second opening 7-1, 7-2 of the valve body 3 to the further ports 6-1 to 6-3 of the housing 2 can be created. The axes of the flow channels 8-1 to 8-3 are each perpendicular to one another for this purpose, wherein the axis of the first flow channel 8-1 coincides with the adjustment axis A.

FIGS. 4A to 4D illustrate the different angle position of the valve body 3 in relation to the adjustment axis A inside the housing 2. In the illustrations of FIGS. 4A to 4D, the central port 5 is below the drawing plane and the actuating device 9 is viewed from above in the direction of the adjustment axis A.

In a first angle position in relation to the adjustment axis A, which is also referred to as 0° angle position and is shown in FIG. 4A, the second flow channel 8-2 is fluidically connected to the first further port 6-1 and the third flow channel 8-3 is fluidically connected to the second further port 6-2.

In a second angle position, which is also referred to as 90° angle position and is shown in FIG. 4B, the valve body 3 has been rotated 90° clockwise about the adjustment axis A. With this second angle position, the second flow channel 8-2 is fluidically connected to the second further port 6-2 and the third flow channel 8-3 is fluidically connected to the third further port 6-3.

In a third angle position of the valve body 3, which is shown in FIG. 4C and which is referred to as 180° angle position, the valve body 3 has again been rotated 90° clockwise about the adjustment axis A, so that the second flow channel 8-2 is fluidically connected to the third further port 6-3. In contrast, the third flow channel 8-3 is blocked by the housing 2, as is shown in FIG. 4C.

In a fourth angle position, which is shown in FIG. 4D and which is referred to as 270° angle position, the valve body 3 has been rotated a further 90° about the adjustment axis A, so that in this case the second flow channel 8-2 is blocked by the housing 2 and the third flow channel 8-3 is fluidically connected to the first further port 6-1.

In a further exemplary embodiment, the valve body 3 is not spherical, but cylindrical. Accordingly, in this case the housing cavity does not form a sphere, but a hollow cylinder. In this case, the first opening of the valve body is formed at one of the end faces of the cylindrical valve body and, in this case, the second and third opening of the valve body is formed on the lateral surface of the cylindrical valve body. In this case, however the valve body can interact with the ports of the housing in the same manner.

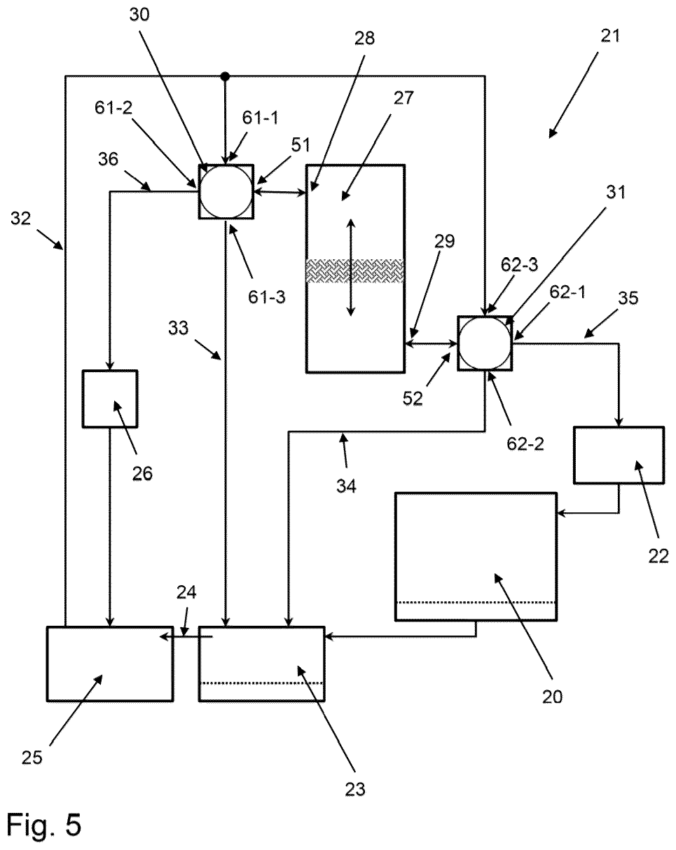

With reference to FIGS. 5 to 10, an exemplary embodiment of the liquid treatment installation 21 of a vehicle washing installation 20 is described:

The vehicle washing installation 20 has a collection channel from which the dirty washing water is supplied to a sedimentation tank 23. The solid particles settle on the bottom in the sedimentation tank 23. In the upper region, the sedimentation tank 23 has a drain 24, via which the washing water cleaned of dirt particles reaches a discharge tank 25. The discharge tank 25 is connected to a first valve arrangement 30 and to a second valve arrangement 31 via a discharge line 32. In the present exemplary embodiment, the construction of the two valve arrangements 30 and 31 is the one described above for the valve arrangement 1 with reference to FIGS. 1 to 4. In this case, the discharge line 32 is connected to the first further port 61-1 of the first valve arrangement 30 and the third further port 62-3 of the second valve arrangement 31. The central port 51 of the first valve arrangement 30 is connected to the inlet 28 of the filter device 27. The outlet 29 of the filter device 27 is connected to the central port 52 of the second valve arrangement 31.

The third further port 61-3 of the first valve arrangement 30 is connected to the sedimentation tank 23 via a first recirculation line 33. Likewise, the second further port 62-2 of the second valve arrangement 31 is connected to the sedimentation tank 23 via a second recirculation line 34. Furthermore, the second further port 61-2 of the first valve arrangement 30 is connected to a treatment system 26 via a circulation line 36. The outlet of the treatment system 26 is in turn connected to the discharge tank 25. Finally, the first further port 62-1 of the second valve arrangement 31 is connected to a liquid reservoir 22 via a reservoir line 35. The industrial water collected in the liquid reservoir 22 is supplied to the vehicle washing installation 20 for cleaning the vehicles.

Corresponding pumps are provided for liquid circulation, which however are not shown in FIG. 5.

The first and second valve arrangement 30, 31 are electronically controlled via the respectively assigned actuating devices 9 of the valve arrangements 30, 31. In this manner, the valve bodies 3 of the valve arrangements 30, 31 can each be rotated quickly 90° about the respective adjustment axis A, in order to align the flow channels 8 of the respective valve bodies 3 with the further ports 61-1 to 61-3 and 62-1 to 62-3.

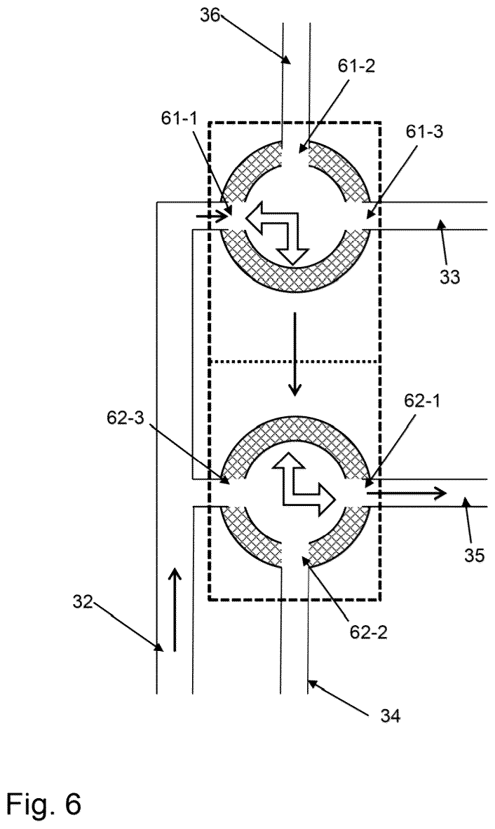

Explained in the following with reference to FIGS. 6 to 10 are the different flow paths which can be realised by the different angle positions of the valve bodies of the valve arrangements 30 and 31. As in FIG. 4, in the illustrations of FIGS. 6 to 10, the central port 51 or 52 is below the drawing plane and the respective actuating device 9 of the valve arrangement 30 and 31 is viewed from above in the direction of the adjustment axis A.

FIG. 6 shows the angle positions of the valve bodies 3 of the first and second valve arrangement 30, 31 for the flow path of the liquid for filtering in the normal operation of the liquid treatment installation. The valve body 3 of the first valve arrangement 30 is located in the 270° angle position. Likewise, the valve body 3 of the second valve arrangement 31 is located in the 270° angle position. In this case, the liquid is pumped from the discharge tank 25 through the discharge line 32 to the valve arrangements 30 and 31. The passage is blocked at the second valve arrangement 31. In the first valve arrangement 30, the liquid enters and gets into the junction chamber 4 of the valve body 3 of the first valve arrangement 30 via the third flow channel 8-3 of the valve body 3. From there, the liquid gets through the first flow channel 8-1 and the central port 51 of the first valve arrangement 30 to the inlet 28 of the filter device 27. The liquid is then filtered in the filter device 27 and enters the central port 52 of the second valve arrangement 31 at the outlet 29 of the filter device 27.

As can be seen from the position of the valve body 3 of the second valve arrangement 31 shown in FIG. 6, the liquid gets from there into the liquid reservoir 22 via the reservoir line 35. The filtered liquid can therefore be provided to the vehicle washing installation 20 as industrial water. After the recirculation via the sedimentation tank 23 into the discharge tank 25, the flow path for filtering is closed.

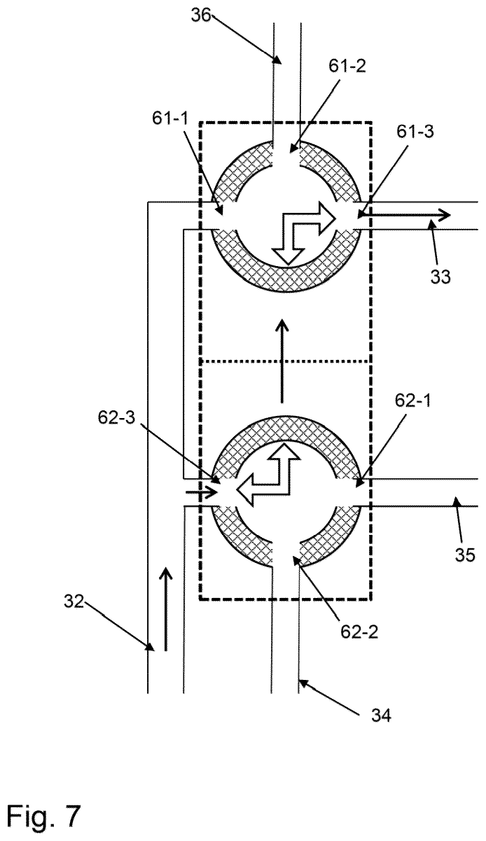

FIG. 7 shows the angle positions of the valve bodies 3 of the first and second valve arrangement 30, 31 for a flow path of the liquid for backwashing the filter. In this case, the angle positions of the valve bodies 3 of the first and second valve arrangement 30, 31 are at 180°, as shown in FIG. 4C. At these angle positions of the valve bodies 3, the liquid is removed from the discharge tank 25 by means of a pump and flows to the valve arrangements 30 and 31 via the discharge line 32. The first further port 61-1 of the first valve arrangement 30, which is connected to the discharge line 32, is closed in the angle position of the valve body 3 of the first valve arrangement 30. The third further port 62-3 of the second valve arrangement 31, which is also connected to the discharge line 32, in contrast is open, so that the liquid flows into the second valve arrangement 31 via the third further port 62-3 of the latter and flows into the filter device 27 in the reverse direction via the central port 52 of the second valve arrangement 31. The liquid flows through the filter device 27 in the reverse direction, whereby dirt particles are swirled up in the filter of the filter device 27. The liquid then reaches the third further port 61-3 of the first valve arrangement 30 via the central port 51 of the first valve arrangement 30 and gets into the first recirculation line 33, as shown in FIG. 7. From there, the liquid, which contains the dirt particles from the filter, gets into the sedimentation tank 23, where the dirt particles settle. The liquid is then returned to the discharge tank 25 via the drain 24 of the sedimentation tank 23, whereby the circuit for backwashing is closed.

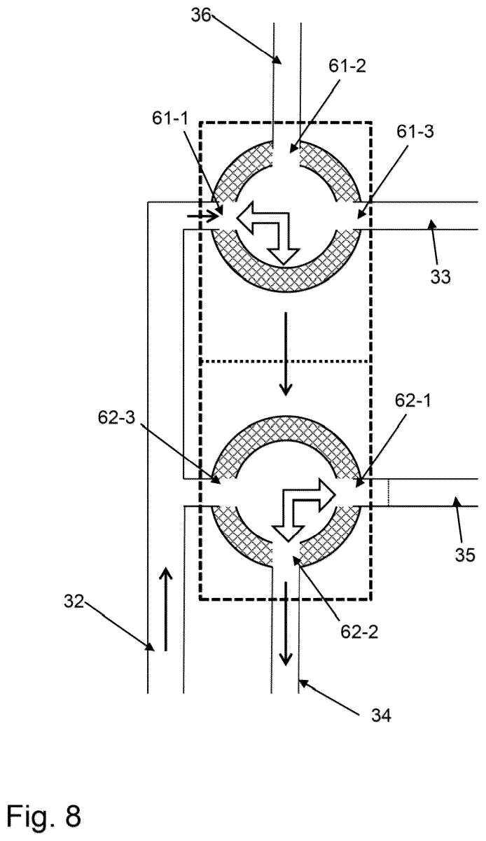

FIG. 8 shows the angle positions of the valve bodies 3 of the first and second valve arrangement 30, 31 for the flow path of the liquid for compacting the filter bed. The valve body 3 of the first valve arrangement 30 is located in the 270° angle position, as shown in FIG. 4D, whereas the valve body 3 of the second valve arrangement 31 is located in the 0° angle position, as shown in FIG. 4A. The flow path provided by these angle positions of the valve bodies 3 of the valve arrangements 30, 31 is usually chosen after backwashing the filter device 27.

In this case, the liquid is pumped from the discharge tank 25. As shown in FIG. 8, it then enters into the first valve arrangement 30 via the first further port 61-1 of the first valve arrangement 30 and from there gets into the filter device 27 via the central port 51 of the first valve arrangement 30. The filter device 27 is flowed through and then gets into the junction chamber 4 of the second valve arrangement 31 from the outlet 29 of the filter device 27 and the central port 52 of the second valve arrangement 31. From there, the passages are open at the first further port 62-1 and the second further port 62-2 of the second valve arrangement 31. The first further port 62-1 is connected to the reservoir line 35, which leads into the liquid reservoir 22. There, a counterpressure results from the liquid located in the liquid reservoir 22. In contrast, the second further port 62-2 of the second valve arrangement 31 is connected to the second recirculation line 34, which leads into the sedimentation tank 23. At this second further port 62-2, there is no counterpressure, so that the liquid only flows back into the sedimentation tank 23. From there, it returns to the discharge tank 25. Thus, the liquid circulates through the filter device 27 without getting into the vehicle washing installation 20 via the liquid reservoir 22, and therefore compacts the filter bed.

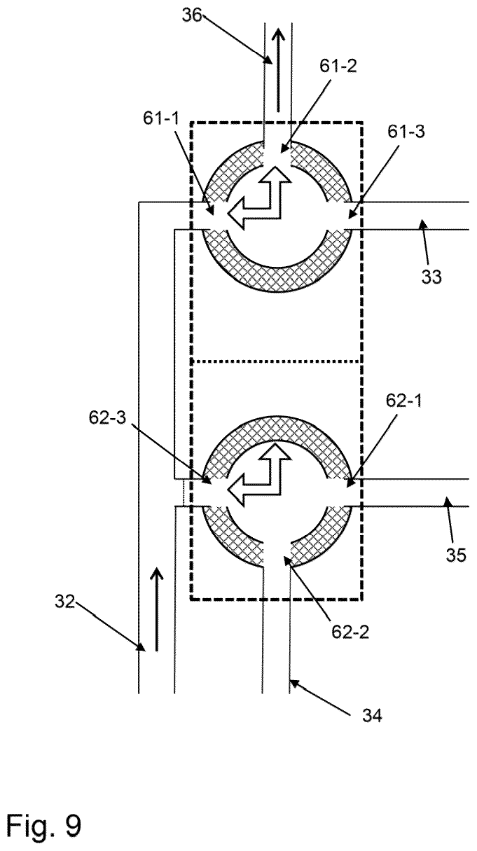

FIG. 9 shows the angle positions of the valve bodies 3 of the first and second valve arrangement 30, 31 for a flow path for circulation through the treatment system 26. In this case, the angle position of the valve body 3 of the first valve arrangement 30 is the 0° angle position and the valve body 3 of the second valve arrangement 31 is located in the 180° angle position.

In this case, liquid is pumped from the discharge tank 25 via the discharge line 32 to the valve arrangements 30, 31. The flow to both the inlet 28 of the filter device 27 as well as to the outlet 29 of the filter device 27 is opened, on the one hand via the first further port 61-1 of the first valve arrangement 30 and on the other hand via the third further port 62-3 of the second valve arrangement 31; see FIG. 9. Thus, the inlet 28 as well as the outlet 29 of the filter device 27 is subjected to pressure. As a result, liquid does not pass through the filter device 27. Instead, the liquid flows into the circulation line 36 via the second further port 61-2 of the valve arrangement 30 and from there into the treatment system 26. From the treatment system 26, the liquid flows back into the discharge tank 25, whereby the circuit is closed. In these angle positions of the valve bodies 3 of the first and second valve arrangements 30, 31, the liquid therefore circulates through the treatment system 26 without flowing through the filter device 27 and without flowing through the vehicle washing installation 20. In this manner, the liquid can be subjected to treatment, such as ozonation, a chemical treatment or treatment in a bioreactor. The circulation itself takes place without pressure, as the filter device 27 is not flowed through and only the line resistances have to be overcome.

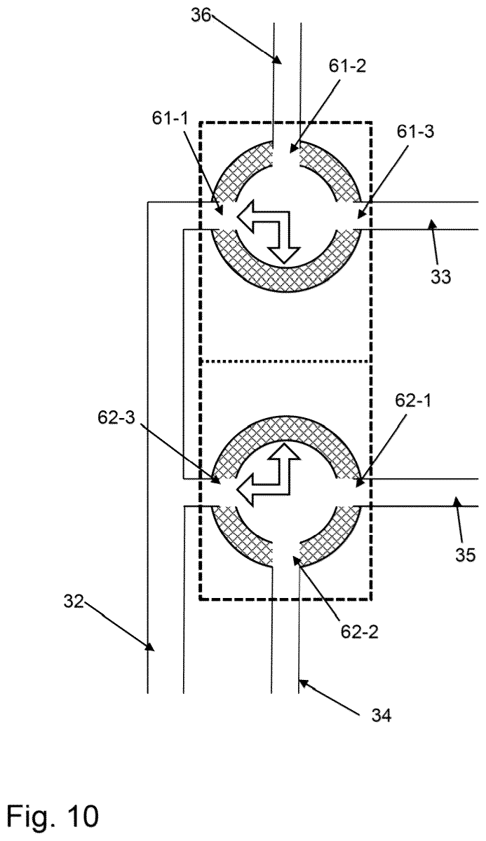

Finally, in FIG. 10, angle positions of the valve bodies 3 of the valve arrangements 30 and 31 are shown, in which all passages are closed. The valve body 3 of the first valve arrangement 30 is located in the 270° angle position; the valve body 3 of the second valve arrangement 31 is located in the 180° angle position. As with the flow path shown in FIG. 9, in this case both the inlet 28 as well as the outlet 29 of the filter device 27 is subjected to pressure so that, as a result, liquid does not flow through the filter device 27. Further flow through the valve arrangements 30, 31 is not possible, as is shown in FIG. 10, so that liquid flow does not occur.

### LIST OF REFERENCE NUMERALS

1 valve arrangement
2 housing
3 valve body
4 junction chamber
5 central port
6-1 first further port
6-2 second further port
6-3 third further port
7-1 first opening of the valve body
7-2 second opening of the valve body
7-3 third opening of the valve body
8-1 first flow channel
8-2 second flow channel
8-3 third flow channel
9 actuating device
20 vehicle washing installation
21 liquid treatment installation
22 liquid reservoir
23 sedimentation tank
24 drain of the sedimentation tank
25 discharge tank
26 treatment system
27 filter device
28 inlet of the filter device
29 outlet of the filter device
30 first valve arrangement
31 second valve arrangement
32 discharge line
33 first recirculation line
34 second recirculation line
35 reservoir line
36 circulation line
51 central port of the first valve arrangement
52 central port of the second valve arrangement
61-1 first further port of the first valve arrangement
61-2 second further port of the first valve arrangement
61-3 third further port of the first valve arrangement
62-1 first further port of the second valve arrangement
62-2 second further port of the second valve arrangement
62-3 third further port of the second valve arrangement

1. A valve arrangement comprising:
a housing, which has a central port and at least three further ports and surrounds a housing cavity in which a valve body is arranged so as to rotate about an actuatable adjustment axis relative to the housing,
wherein each of the ports of the housing is fluidically connected to the housing cavity,
wherein the valve body has at least one first, one second and one third flow channel, which in each case extend from a first, a second and a third assigned opening to a common junction chamber,
wherein the openings of the valve body and the ports of the housing are arranged so that
the adjustment axis runs through the first opening and the first flow channel is fluidically connected to the central port and
in a first angle position of the valve body in relation to the adjustment axis, the second flow channel is fluidically connected to a first of the at least three further ports and the third flow channel is fluidically connected to a second of the at least three further ports.

2. The valve arrangement according to claim 1, wherein in a second angle position of the valve body in relation to the adjustment axis, the second flow channel is fluidically connected to the second port and the third flow channel is fluidically connected to a third of the at least three further ports.

3. The valve arrangement according to claim 2, wherein in a third angle position of the valve body in relation to the adjustment axis, the second flow channel is fluidically connected to the third port and the third flow channel is blocked by the valve body.

4. The valve arrangement according to claim 3, wherein in a fourth angle position of the valve body in relation to the adjustment axis, the second flow channel is blocked by the valve body and the third flow channel is fluidically connected to the first port.

5. The valve arrangement according to claim 1, wherein the axes of the flow channels are each perpendicular to one another, wherein the axis of the first flow channel (lies on the adjustment axis.

6. The valve arrangement according to claim 1, wherein the housing cavity is a hollow sphere and the valve body is spherical so that the spherical valve body sits sealingly in the hollow sphere formed by the housing.

7. The valve arrangement according to claim 1, wherein the housing cavity is a hollow cylinder, the axis of which coincides with the adjustment axis, and the valve body is cylindrical so that the cylindrical valve body sits sealingly in the hollow cylinder formed by the housing.

8. A liquid treatment installation for a vehicle washing installation, the liquid treatment installation comprising:
a liquid reservoir for the vehicle washing installation,
a sedimentation device for removing sediment and
a filter device having an inlet and an outlet,
wherein a valve system which, in a first switching position, guides liquid from the sedimentation device into the inlet of the filter device, through the filter device and from the outlet of the filter device into the liquid reservoir and, in a second switching position, supplies liquid from the sedimentation device past a treatment system to the filter device.

9. The liquid treatment installation according to claim 8, wherein the sedimentation device has a sedimentation tank and a discharge tank, wherein a drain of the sedimentation tank is fluidically connected to the discharge tank.

10. A liquid treatment installation for a vehicle washing installation, the liquid treatment installation comprising:
a liquid reservoir for the vehicle washing installation,
a sedimentation device for removing sediment and
a filter device having an inlet and an outlet,
wherein a valve system which, in a first switching position, guides liquid from the sedimentation device into the inlet of the filter device, through the filter device and from the outlet of the filter device into the liquid reservoir and, in a second switching position, supplies liquid from the sedimentation device past a treatment system to the filter device,
wherein the valve system has a first valve arrangement according to claim 1.

11. The liquid treatment installation according to claim 10, wherein the central port of the first valve arrangement is connected to the inlet of the filter device.

12. The liquid treatment installation according to claim 10, wherein the first port of the first valve arrangement is connected to a discharge tank of the sedimentation device, the second port of the first valve arrangement is connected to the treatment system, and the third port of the first valve arrangement is connected to a sedimentation tank of the sedimentation device.

13. A liquid treatment installation for a vehicle washing installation, the liquid treatment installation comprising:
a liquid reservoir for the vehicle washing installation,
a sedimentation device for removing sediment and
a filter device having an inlet and an outlet,
wherein a valve system which, in a first switching position, guides liquid from the sedimentation device into the inlet of the filter device, through the filter device and from the outlet of the filter device into the liquid reservoir and, in a second switching position, supplies liquid from the sedimentation device past a treatment system to the filter device,
wherein the valve system has a first and second valve arrangements according to claim 1.

14. The liquid treatment installation according to claim 13, wherein the central port of the second valve arrangement is connected to the outlet of the filter device.

15. The liquid treatment installation according to claim 13,
wherein the first port of the second valve arrangement is connected to the liquid reservoir,
wherein the second port of the second valve arrangement is connected to a discharge tank of the sedimentation device, and
wherein the third port of the second valve arrangement is connected to a sedimentation tank of the sedimentation device.
